(19) United States
(12) Patent Application Publication
(10) Pub. No.: US 2012/0022954 A1
(43) Pub. Date: Jan. 26, 2012

(54) CLOUD BASED MEDIA PLAYER AND OFFLINE MEDIA ACCESS

(75) Inventors: David Garcia, Sunnyvale, CA (US); Brett Wilson, Sunnyvale, CA (US)

(73) Assignee: Google Inc., Mountain View, CA (US)

(21) Appl. No.: 13/246,841

(22) Filed: Sep. 27, 2011

Related U.S. Application Data
(63) Continuation of application No. 12/903,190, filed on Oct. 12, 2010.
(60) Provisional application No. 61/251,286, filed on Oct. 13, 2009.
(60) Provisional application No. 61/360,161, filed on Jun. 30, 2010.

(51) Int. Cl. G06Q 30/00

(52) U.S. Cl. 705/14.73

(57) ABSTRACT

According to one general aspect, a method for playing, in an offline mode, a media file may include receiving, by a web browser operating in an online mode and from a content server, a media file and at least one advertisement associated with the media file. The method may further include caching, within a local file system, the media file and the at least one advertisement. The method may also include playing, in an offline mode, the cached media file and the cached at least one advertisement. The method also comprise detecting a user interaction, while in an offline mode, with the at least one advertisement. The method may include caching the user interaction for further processing when in an online mode.

### CROSS-REFERENCE TO RELATED APPLICATION

This application is a continuation of, and claims priority under 35 U.S.C. §120 to, application Ser. No. 12/903,190, filed on Oct. 12, 2010 and entitled “CLOUD BASED MEDIA PLAYER AND OFFLINE MEDIA ACCESS”, which claims the priority benefit, under 35 U.S.C. §119, of U.S. Provisional Application 61/251,286, filed Oct. 13, 2009, titled “POWER MANAGEMENT AND DATA CACHING IN A COMPUTING PLATFORM,” and of U.S. Provisional Application Ser. No. 61/360,161, entitled “CLOUD BASED MEDIA PLAYER AND OFFLINE MEDIA ACCESS” filed on Jun. 30, 2010. The subject matter of these earlier filed applications are hereby incorporated by reference.

### TECHNICAL FIELD

This description relates to storage and playing of media or content, and more specifically the caching of media and advertisements for offline use.

### BACKGROUND

In media production and publishing, the term “content” includes information and experiences that may provide value for an end-user/audience in specific contexts. Content may be delivered via any medium such as the internet, television, and audio CDs, as well as live events such as conferences and stage performances. The word is used to identify and quantify various formats and genres of information as manageable value-adding components of media. Generally, the term “media file” refers to a file in which “content” is contained. In various embodiments, a “media file” may include a movie, television (TV) show, audiobook, ebook, music, etc.

Generally, media (movies or audiobooks, etc.) may be streamed from a media company's content server to a user's device (e.g., computer, smartphone, etc.). When streaming media, the user is expected to consume (watch, listen to, etc.) the media immediately. The media is generally not cached (although some buffering may occur) and if the media is not consumed it is removed from the user's device. Further, in order for the media file to be streamed the user's device and the content server must generally maintain communication for the duration of the streaming of the media file. If the network connection between the two devices is lost for an extended period of time, the streaming will cease. Examples of such media streaming services include Hulu, Netflix's Instant Watch, Amazon's Video on Demand (VoD), Pandora, etc.

Occasionally, advertisements are shown or included in these streaming media files. Such advertisements are frequently similar to the traditional TV model of advertising. At a certain time in the streamed media or program, the main program may be paused or stopped and an advertisement may be played.

### SUMMARY

According to one general aspect, a method for playing, in an offline mode, a media file may include receiving, by a web browser operating in an online mode and from a content server, a media file and at least one advertisement associated with the media file. The method may further include caching, within a local file system, the media file and the at least one advertisement. The method may also include playing, in an offline mode, the cached media file and the cached at least one advertisement. The method also comprise detecting a user interaction, while in an offline mode, with the at least one advertisement. The method may include caching the user interaction for further processing when in an online mode.

According to another general aspect, an apparatus may include an operating system, a digital rights management (DRM) module, a non-volatile memory, and a media player. The apparatus may be configured to operate in an online mode and an offline mode, wherein when operating in the online mode the apparatus is communicatively coupled to a content server, and when operating in the offline mode the apparatus is not communicatively coupled to the content server. The operating system may be configured to receive, from the content server, a media file and at least one advertisement associated with the media file. The digital rights management (DRM) module may be configured to cache, within a local file system, the media file and the at least one advertisement. The non-volatile memory may be configured to store the local file system. The media player may be configured to play, while the apparatus is operating in the offline mode, the cached media file and the cached at least one advertisement, detect a user interaction, while the apparatus is operating in the offline mode, with the at least one advertisement, and cache the user interaction for further processing when the apparatus is operating in the online mode.

According to another general aspect, a computer-readable medium may be tangibly embodied and including executable code that causes a media playing apparatus to receive, by the media playing apparatus operating in an online mode and from a content server, a media file and at least one advertisement associated with the media file. The media playing apparatus may also cache, within a local file system, the media file and the at least one advertisement. The apparatus may play, in an offline mode, the cached media file and the cached at least one advertisement. The instructions may further cause the apparatus to detect a user interaction, while in an offline mode, with the at least one advertisement. The apparatus may cache the user interaction for further processing when in an online mode.

The details of one or more implementations are set forth in the accompanying drawings and the description below. Other features will be apparent from the description and drawings, and from the claims.

A system and/or method for storing and playing information, substantially as shown in and/or described in connection with at least one of the figures, as set forth more completely in the claims.

### BRIEF DESCRIPTION OF THE DRAWINGS

FIG. 1 is a block diagram of an example embodiment of a system in accordance with the disclosed subject matter.

FIG. 2 is a block diagram of an example embodiment of a system in accordance with the disclosed subject matter.

FIG. 3 is a diagram of an example embodiment of a web browser in accordance with the disclosed subject matter.

FIG. 4 is a diagram of an example embodiment of a metadata file in accordance with the disclosed subject matter.

FIG. 5 is a diagram of an example embodiment of a usage data file in accordance with the disclosed subject matter.

FIG. 6 is a diagram of an example embodiment of media and advertisement files in accordance with the disclosed subject matter.

FIG. 7 is a flow chart of an example embodiment of a technique in accordance with the disclosed subject matter.

Like reference symbols in the various drawings indicate like elements.

### DETAILED DESCRIPTION

Described herein is a device and a technique for operating a device, application, or web browser in either an online mode or an offline mode. In the online mode, the device may download and cache one or e more media files (e.g., movies, television shows, audio recordings, etc.) and one or more advertisements associated with the various media files (e.g., commercials, text advertisements, web pages, etc.). When in the offline mode, the device may play the cached media files and their associated advertisement(s). The user's interactions with the advertisement(s) (e.g., selecting a hyperlink, attempting to buy the advertised product, etc.) may be cached. Upon returning to the online mode, these user interactions may be processed (e.g., opening the destination of the selected hyperlink, submitting the user's payment information and product order, etc.). It is understood that the above are merely a few illustrative examples to which the disclosed subject matter is not limited.

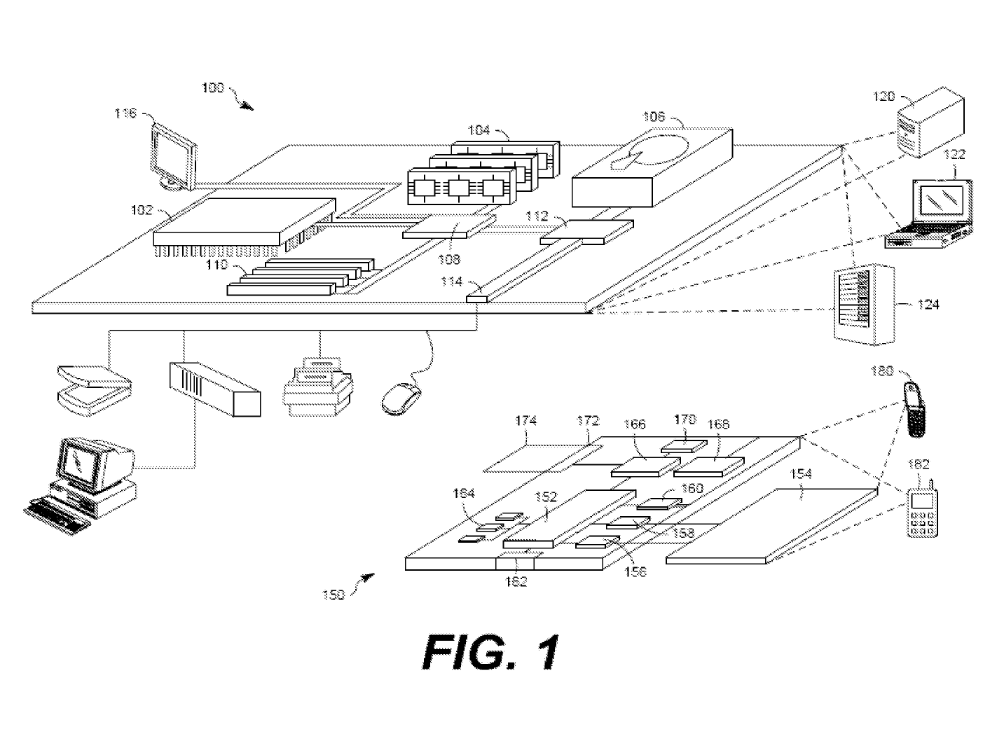

FIG. 1 shows an example of a generic computer device 100 and a generic mobile computer device 150, which may be used with the techniques described here. Computing device 100 is intended to represent various forms of digital computers, such as laptops, desktops, workstations, personal digital assistants, servers, blade servers, mainframes, and other appropriate computers. Computing device 150 is intended to represent various forms of mobile devices, such as personal digital assistants, cellular telephones, smart phones, tablets, and other similar computing devices. The components shown here, their connections and relationships, and their functions, are meant to be exemplary only, and are not meant to limit implementations of the inventions described and/or claimed in this document.

Computing device 100 includes a processor 102, memory 104, a storage device 106, a high-speed interface 108 connecting to memory 104 and high-speed expansion ports 110, and a low speed interface 112 connecting to low speed bus 114 and storage device 106. Each of the components 102, 104, 106, 108, 110, and 112, are interconnected using various busses, and may be mounted on a common motherboard or in other manners as appropriate. The processor 102 can process instructions for execution within the computing device 100, including instructions stored in the memory 104 or on the storage device 106 to display graphical information for a graphical user interface (GUI) on an external input/output device, such as display 116 coupled to high speed interface 108. In other implementations, multiple processors and/or multiple buses may be used, as appropriate, along with multiple memories and types of memory. Also, multiple computing devices 100 may be connected, with each device providing portions of the necessary operations (e.g., as a server bank, a group of blade servers, or a multi-processor system, etc.).

The memory 104 stores information within the computing device 100. In one implementation, the memory 104 includes a volatile memory unit or units. In another implementation, the memory 104 includes a non-volatile memory unit or units. The memory 104 may also be another form of computer-readable medium, such as a magnetic or optical disk.

The storage device 106 is capable of providing mass storage for the computing device 100. In one implementation, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 104, the storage device 106, or memory on processor 102.

The high speed controller 108 manages bandwidth-intensive operations for the computing device 100, while the low speed controller 112 manages lower bandwidth-intensive operations. Such allocation of functions is exemplary only. In one implementation, the high-speed controller 108 is coupled to memory 104, display 116 (e.g., through a graphics processor or accelerator), and to high-speed expansion ports 110, which may accept various expansion cards (not shown). In the implementation, low-speed controller 112 is coupled to storage device 106 and low-speed expansion port 114. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 100 may be implemented in a number of different forms, as shown in the figure. For example, it may be implemented as a standard server 120, or multiple times in a group of such servers. It may also be implemented as part of a rack server system 124. In addition, it may be implemented in a personal computer such as a laptop computer 122. Alternatively, components from computing device 100 may be combined with other components in a mobile device (not shown), such as device 150. Each of such devices may contain one or more of computing device 100, 150, and an entire system may be made up of multiple computing devices 100, 150 communicating with each other.

Computing device 150 includes a processor 152, memory 164, an input/output (I/O) device such as a display 154, a communication interface 166, and a transceiver 168, among other components. The device 150 may also be provided with a storage device, such as a micro-drive or other device, to provide additional storage. Each of the components 150, 152, 164, 154, 166, and 168, are interconnected using various buses, and several of the components may be mounted on a common motherboard or in other manners as appropriate.

The processor 152 can execute instructions within the computing device 150, including instructions stored in the memory 164. The processor may be implemented as a chipset of chips that include separate and multiple analog and digital processors. The processor may provide, for example, for coordination of the other components of the device 150, such as control of user interfaces, applications run by device 150, and wireless communication by device 150.

Processor 152 may communicate with a user through control interface 158 and display interface 156 coupled to a display 154. The display 154 may be, for example, a TFT LCD (Thin-Film-Transistor Liquid Crystal Display) or an OLED (Organic Light Emitting Diode) display, or other appropriate display technology. The display interface 156 may comprise appropriate circuitry for driving the display 154 to present graphical and other information to a user. The control interface 158 may receive commands from a user and convert them for submission to the processor 152. In addition, an external interface 162 may be provide in communication with processor 152, so as to enable near area communication of device 150 with other devices. External interface 162 may provide, for example, for wired communication in some implementations, or for wireless communication in other implementations, and multiple interfaces may also be used.

The memory 164 stores information within the computing device 150. The memory 164 can be implemented as one or more of a computer-readable medium or media, a volatile memory unit or units, or a non-volatile memory unit or units. Expansion memory 174 may also be provided and connected to device 150 through expansion interface 172, which may include, for example, a SIMM (Single In Line Memory Module) card interface. Such expansion memory 174 may provide extra storage space for device 150, or may also store applications or other information for device 150. Specifically, expansion memory 174 may include instructions to carry out or supplement the processes described above, and may include secure information also. Thus, for example, expansion memory 174 may be provide as a security module for device 150, and may be programmed with instructions that permit secure use of device 150. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 164, expansion memory 174, or memory on processor 152, that may be received, for example, over transceiver 168 or external interface 162.

Device 150 may communicate wirelessly through communication interface 166, which may include digital signal processing circuitry where necessary. Communication interface 166 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 168. In addition, short-range communication may occur, such as using a Bluetooth, WiFi, or other such transceiver (not shown). In addition, GPS (Global Positioning System) receiver module 170 may provide additional navigation- and location-related wireless data to device 150, which may be used as appropriate by applications running on device 150.

Device 150 may also communicate audibly using audio codec 160, which may receive spoken information from a user and convert it to usable digital information. Audio codec 160 may likewise generate audible sound for a user, such as through a speaker, e.g., in a handset of device 150. Such sound may include sound from voice telephone calls, may include recorded sound (e.g., voice messages, music files, etc.) and may also include sound generated by applications operating on device 150.

The computing device 150 may be implemented in a number of different forms, as shown in the figure. For example, it may be implemented as a cellular telephone 180. It may also be implemented as part of a smart phone 182, personal digital assistant, or other similar mobile device.

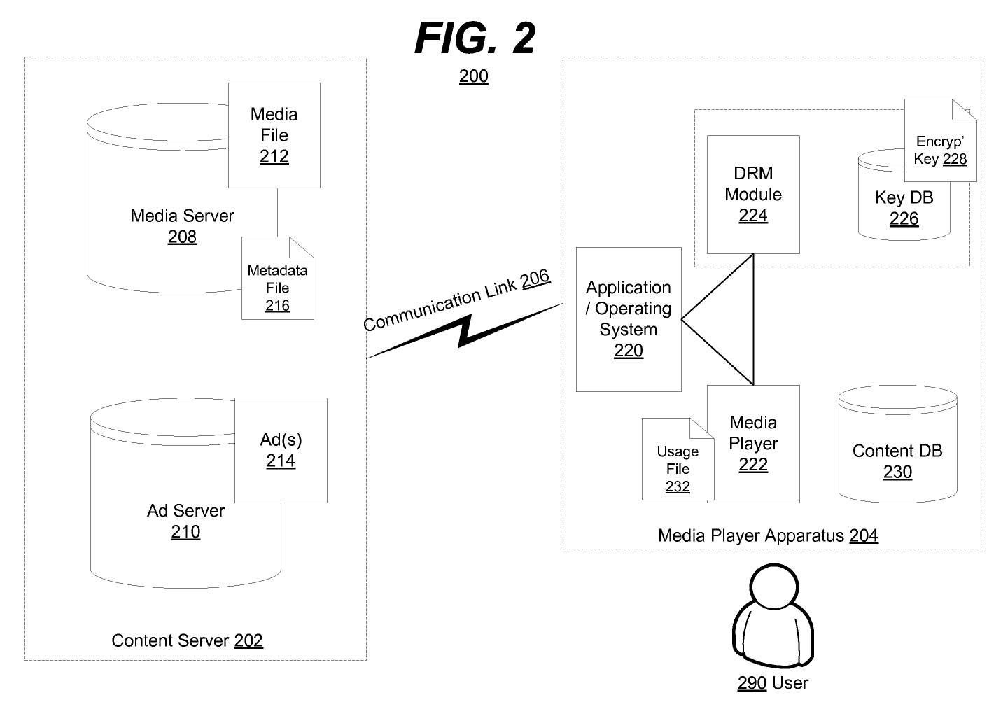

FIG. 2 is a block diagram of an example embodiment of a system 200 in accordance with the disclosed subject matter. In one embodiment, the system 200 may include a content server 202 and a media player apparatus 204. It is understood that while only one content server 202 is shown, the system may include a number of such servers, for example, one for each content provider (e.g., Amazon, Netflix, Paramount, etc.). Likewise, while a single media player apparatus 204 is shown, it is understood that system 200 may include multiple such devices, possibly more than one per user.

In one embodiment, the content server 202 may be configured to serve or distribute media files 212. For purposes of illustration, the content server 202 may be configured to serve television shows or more generally video files; although it is understood any type of media files may be served (e.g., audiobooks, music, ebooks, magazines, movies, etc.).

In one embodiment, the media player apparatus 204 may include an application 220, a media player 222, and a digital rights management (DRM) module 224. In various embodiments, the application 220 may act as the operating system for the media player apparatus 204. In the illustrated embodiment, the application 220 may be referred to as a web browser; however, it is understood that other applications (e.g., a stand-alone media player, etc.) may be used. It is understood that the above are merely a few illustrative examples to which the disclosed subject matter is not limited. Further the content database (DB) 230 and/or the encryption key DB 226 may be stored within a non-volatile memory included by the apparatus 204.

In various embodiments, a user 290 may wish to watch or consume a media file 212 via the media player apparatus 204. In such an embodiment, the user may access the content server 202 using the application 220. At this point the media player apparatus 204 may be connected to a communications network (e.g., the Internet, etc.), and communicate with the content server 202 via a communication link 206. This communication link 206 may be wired or wireless or a combination thereof. When this communication link 206 between the content server 202 and the media player apparatus 204 is functioning, the media player apparatus 204 or the application 220 may be said to be operating in an “online mode”.

The terms “online” and “offline” have specific meanings in regard to computer technology and telecommunications. In general, “online” indicates a state of connectivity or, in this context, that the content server 202 and the media player apparatus 204 are communicatively coupled. In contrast, “offline” indicates a disconnected state specifically that the content server 202 and the media player apparatus 204 are not communicatively coupled. It is noted that the media player apparatus 204 may operate in an “offline mode”, and not communicate with the content server 202 even if the apparatus 204 is coupled to a network (e.g., the apparatus 204 may be firewalled off from the content server 202 either by an external device or an internal setting, etc.). Further, in various embodiments, the media player apparatus 204 may automatically detect and switch between online and offline modes, and vice versa. Also, a user may be able to manually switch between modes, even if a network connection exists or is possible.

Returning to the example, the user 290 via the application 220 may inform the content server 202 that a media file 212 is requested. In one embodiment, the user 290 may specify that the user 290 would like to download the media file 212 such that the media file 212 may be played when the apparatus 204 is in an offline mode, and not connected to the content server 202. In various embodiments, the application 220 may be configured to determine, based upon the filetype or other indicator (e.g., Multipurpose Internet Mail Extensions (MIME) type, etc.) of the media file 212 whether the media file 212 is being streamed, downloaded as a “purchase”, or downloaded as a cacheable file.

In various embodiments, the content server 202 may be configured to “play” or display advertisements 214 while serving the media file 212. In the streaming case, the content server 202 may be configured to stream a portion of the media file 212, then stream an advertisement 214, and then stream a second portion of the media file 212, and so on, until the media file 212 and the advertisements 214 are finished streaming. As described above, in the TV parlance, the streaming of the media file 212 may include “commercial breaks”. Alternately, the advertisements 214 may be displayed spatially near the media file (e.g., as banners underneath, etc.), although it is understood that the above are merely a few illustrative examples to which the disclosed subject matter is not limited.

Also, in various embodiments, the content server 202 may select a portion of advertisements 214 from a greater number of advertisements to be associated with the media file 212. In various embodiments, the selection may be upon the content of the media file 212, the requesting user 290, demographics, an external consideration unrelated to the media file 212, etc.; although, it is understood that the above are merely a few illustrative examples to which the disclosed subject matter is not limited.

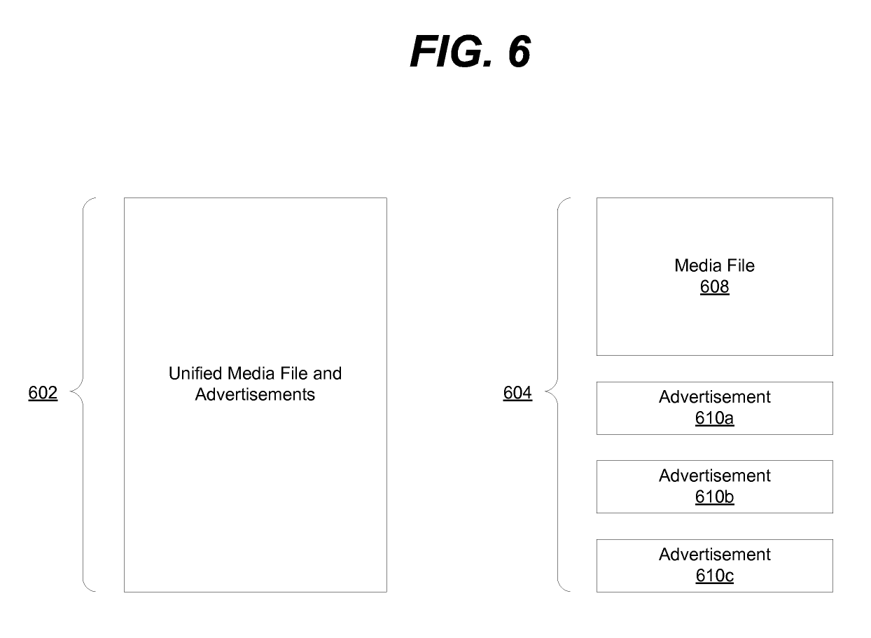

However, in the case of a downloaded media file 212 that is to be cached for offline access or playing, the content server 202 may or may not comingle the media file 212 and the associated advertisements 214. This is further discussed below in reference to FIG. 6. Instead, in one embodiment, the media file 212 and the associated advertisements 214 may be downloaded as separate files. In such an embodiment, the content server 202 may also provide a metadata file 216 that includes instructions regarding the playing of the media file 212 and the advertisements 214. All of these files may be communicated or downloaded to the apparatus 204 via the communications link 206.

In one embodiment, the content server 202 may include multiple sub-servers, for example, a media server 208 and an advertisement or ad server 210. In such an embodiment, the media server 208 may serve the media file 212. Likewise the ad server 210 may serve the advertisements 214. The metadata file 216 may be served in part by the media server 208 (e.g., metadata relating to the media file 212, etc.) and a second portion of the metadata file 216 (e.g., advertisement associations, etc.) may be served from the ad server 210.

In various embodiments, the application 220 may receive the media file 212 and the one or more advertisements 214, and, in some embodiments, the metadata file 216. The application 220 may store or cache these files within the content database 230. In various embodiments, the application 220 may instruct the DRM module 224 to store or cache the received files in the content database (DB) 230.

In one embodiment, the content DB 230 may include a local file system. In some embodiments, the media file 212 may be encrypted by the content server 202. In one embodiment, the DRM module 224 or application 220 may cache the received encrypted media file 212 directly within the content DB 230 or file system. In another embodiment, the DRM module 224 may decrypt the received encrypted media file 212 (for example using an associated encryption key 228) before caching the decrypted media file within the content DB 230 or file system.

In such an embodiment, where the media file 212 is stored in a decrypted state, the content DB 230 may be encrypted itself. In various embodiments, this may allow the media player 222 or DRM module 224 to employ a common or single encryption key 228 to play or access a variety of media files 212. Further, an encrypted content DB 230 may include a separate partition of the apparatus's 204 file system that may not be directly accessed by a user 290, thus protecting the media files 212 from illegitimate copying, etc. In another embodiment, the content DB 230 may not be a separate partition but an encrypted file on the file system. In yet another embodiment, the content DB 230 may be distributed amongst a plurality of storage devices (e.g., non-removable flash memory, removable flash memory, a USB drive, etc.).

In various embodiments, the apparatus 204 may be configured to store a plurality of media files 212 in both a decrypted and/or encrypted state. For example, a first media file from a first provider (e.g., Amazon) may allow storage in a decrypted state of the provided by them, and a second provider (e.g., Netflix) may only allow encrypted storage of their media files. In such an embodiment, the content DB 230 as a whole may be encrypted, as described above, causing the second provider's media files to be encrypted twice, once with the providers encryption key and once with the content DB's 230 general encryption key.

The advertisement files 214 and metadata file 216 may also be cached within the content DB 230. Alternatively, they may be stored or cached within a separate DB or file system (not shown). In various embodiments, these files may be cached in an encrypted or decrypted state. For purposes of simplifying the description of the system 200, these files will be described as being stored in the same manner as their associated media file 212.

Eventually, the user 290 may place the media player apparatus 290 in an offline mode in which the apparatus 204 is no longer commutatively coupled with the content server 202. The user 290 may then wish to watch or consume the media file 212 previously cached for offline access. The user 290 may select the media file 212 that the user 290 wishes to play. In various embodiments, the application 220 may include a file system browser or media browser that allows the user 290 to select one media file 212 from a plurality of cached media files. In some embodiments, this media browser may organize the media files 212 by provider (e.g., Amazon, Netflix, ABC, Paramount, etc.), genre, date, media type (e.g., movie, TV show, audiobook, etc.), etc., although it is understood that the above are merely a few illustrative examples to which the disclosed subject matter is not limited.

Once the desired media file 212 is selected, the application 220 or media browser portion thereof may instruct the DRM module 224 or the media player 222 to access the desired media file 212 and play it. In one embodiment, the DRM module may include or have access to an encryption key database (DB) 226. The encryption key DB 226 may store one or more encryption keys 228 that may be employed to decrypt an encrypted media file 212. The DRM module 224 may retrieve an encryption key 228 associated with the media file 212 or, in the case of an encrypted content DB 230, the content DB 230. The DRM module 224 may decrypt the media file 212 and access or decrypt any associated metadata file 216 and advertisements 214.

The DRM module 224 may access the metadata file 216 to determine if the user 290 has the rights to play the desired media file 212. For example, a metadata file 216 may indicate what if any restrictions are placed on the apparatus's 204 ability to play the media file 212. For example restrictions may include indications that the media file 212 may only be cached for a certain period of time, be playable until a certain date, playable a certain number of times, within a geographic region, at a certain quality (e.g., number of pixels, number of audio tracks, bitrate, etc.), played via a certain port (e.g., the main display, an external video port, only via headphones, etc.), etc. It is understood that the above are merely a few illustrative examples to which the disclosed subject matter is not limited.

In various embodiments, the DRM module 224 may include or make use of a Trusted Platform Module (TPM). In this context, a TPM includes a secure crypto-processor configured to store cryptographic keys that protect information, such as media files. Herein the phrase “the TPM specification” refers to the TPM specification version 1.2, its predecessors or successors. TPM Main Parts 1, 2, and 3, Specification version 1.2, Level 2 revision 103, Jul. 9, 2007, The Trusted Computing Group.

The DRM module 224 may communicate one or more playback restrictions to the media player 222 (e.g., a maximum bitrate, etc.), or may communicate that the media file 212 may not be played (e.g., that the playback period of time has expired, etc.). The media player 222 may be configured to play the media file 212 based upon the restrictions or lack thereof indicated by the DRM module 224.

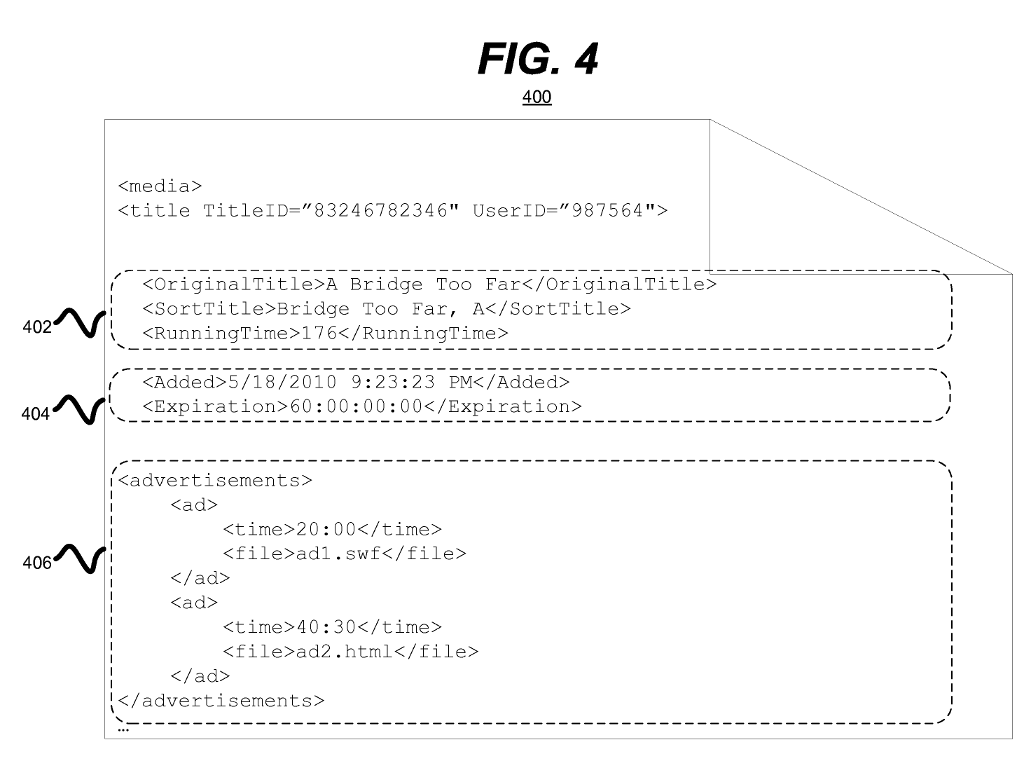

In various embodiments, either the DRM module 224 or the media player 222 may access the associated metadata file 216 to determine what advertisements 214 are associated with the media file 212 and how those advertisements 214 are to be played. In various embodiments, the metadata file 216 may include indications of the above. A more detailed description of an embodiment of a metadata file 214 is given below in reference to FIG. 4. In short, the metadata file 216 may include a list of times, relative to the media file 212, that advertisements 214 are to be played, which advertisements 214 are to be played, where they are to be played (e.g., below where the media file is played, in place of the media file, etc.), etc., although it is understood that the above are merely a few illustrative examples to which the disclosed subject matter is not limited.

The media player 222 may play the media file 212. In various embodiments, the media player 222 may be embedded within or play the media file 212 within the application 220. In one embodiment, the media player 222 or DRM module 224 may organize the media file 212 and advertisements into a playlist. In such an embodiment, the media file 212 may be separated into a plurality of files or the media player may be configured to start playing the media file 212 at a certain point.

In another embodiment, the media player 222 may be configured to play the media file 212 until the indicated time to play the advertisement 214. At that time, the media player 222 may stop playing the media file 212, for example pausing the media file 212 and placing it in the background or otherwise not displaying it to the user 290. The media player 222 may then play the indicated advertisement 214. Upon completion of the advertisement 214, the media player may resume playing the media file 212 at the previously stopped point, or un-pause the media file 212 and return the media file 212 to the foreground or otherwise display the media file to the user 290.

In yet another embodiment in which the separation of the media file 212 and the advertisements is not temporal but spatial, the media player 222 may simultaneously play or display the media file 212 and the advertisement(s) 214 to the user 290. Embodiments that include both temporal and spatial placement of advertisements 214 are contemplated and within the scope of the disclosed subject matter.

In various embodiments, one or more of the advertisements 214 may be interactive in that the user 290 may select the advertisement 214 or a portion thereof and cause an event or action to occur (e.g., going to a web page, selecting a poll option, etc.). The completion of these actions may be possible when the apparatus 204 is operated in an online mode. For example, if a user 290 clicks on an advertisement 214 the application 220 may be able to open the web page pointed to by the advertisement 214 when in online mode. However, when the apparatus 204 is operated in an offline mode, the completion of the selected action may not be possible or convenient.

In one embodiment, when operating in the offline mode, the user 290's interactions with the advertisements 214 may be cached. The media player 222 or application 220 may be configured to detect a user 290 interaction with an advertisement 214. This interaction may be stored within a usage file 232 or within the content DB 230.

In one embodiment, when the application 220 is again operating in an online mode, the application 220 may be configured to read the usage file 232 to determine if any actions caused by user 290 interactions should be completed (e.g., opening a web page, sending an email, etc.). In another embodiment, the media player 222 may report the interactions to the application 220, while in the offline mode, and the application 220 may internally cache or enqueue the actions for performance later when the next online mode occurs.

In various embodiments, the usage file 232 may also include information regarding the user 290′s usage of the media file 212. For example, information regarding how many times the media file 212 was played, where in the playing of the media file 212 the user 290 stopped playing (e.g., resume information), etc. may be stored within the usage file 232. In addition, information regarding the user 290's interaction with the advertisements 214 (e.g., playcount, whether clicked or not, etc.) may be recorded and stored within the usage file 232. In such an embodiment, upon returning to online mode or upon accessing the content server 202 a subsequent time, the usage file 232 or a portion thereof may be transmitted to the content server 202 or a server associated with the content server 202.

In some embodiments, upon returning to online mode or upon accessing the content server 202 a subsequent time, the DRM module 224 or apparatus 204 may be configured to confirm the DRM status of a cached media file 212. For example, the DRM module 224 may be configured to confirm with the content server 202 that the user 290 or apparatus 204 continues to have the rights to access and cache the media file 212. For example, a user 290 may have discontinued their service with the content provider and therefore no longer have the right to media files 212 provided by the content provider and their content server 202, although it is understood that the above is merely one illustrative example to which the disclosed subject matter is not limited. In such an embodiment, if a media file 212 is no longer allowed by the content server 202 to be cached, the DRM module 224 may be configured to delete or purge the media file 212 and its associated advertisements 214 and metadata file 216.

In various embodiments, the apparatus 204 or DRM module 224 may be configured to, upon returning to online mode or upon accessing the content server 202 a subsequent time, update or replace any advertisements 214 associated with cached media files 212. For example, an advertiser may have only contracted for an advertisement to be played during a certain period of time (e.g., July 4^{th} weekend, etc.), and the content server 202 may desire to delete the July 4^{th} advertisement with a more current advertisement. In such an embodiment, the alteration or updating of advertisements 214 may include the alteration of the metadata file 216 associated with the media file 212, as described below.

In such an embodiment, the apparatus 204 or DRM module 224 may download or receive a new metadata file 216 associated with the media file 212. In various embodiments, the new metadata file 216 may merely include changes to the cached metadata file which are to be integrated into cached metadata files.

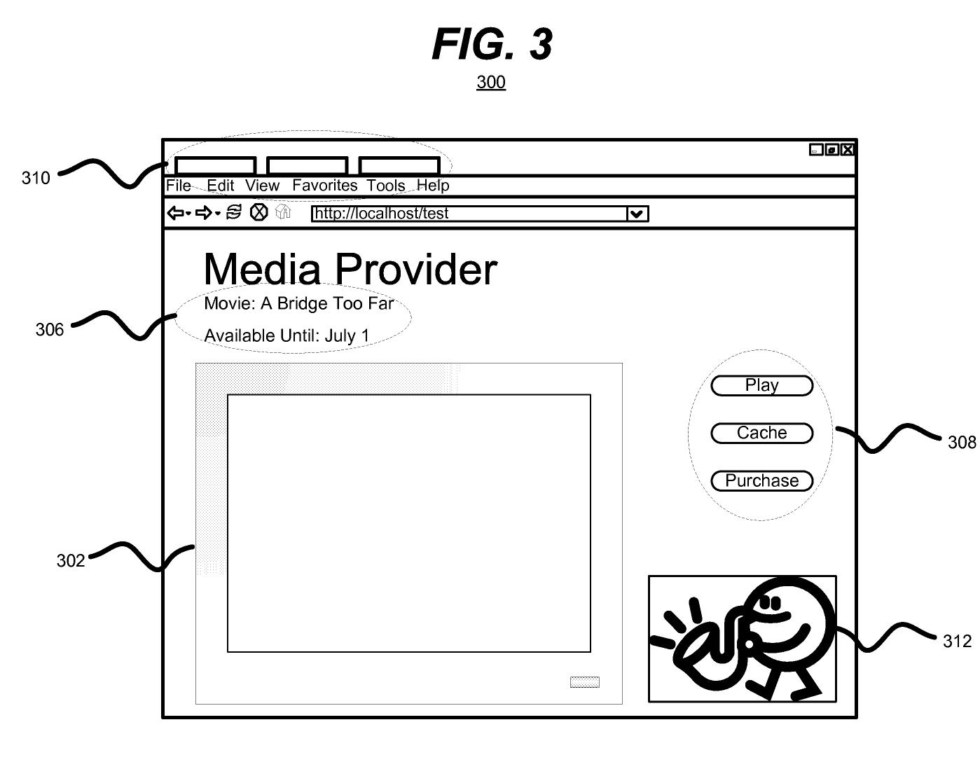

FIG. 3 is a diagram of an example embodiment of a web browser 300 in accordance with the disclosed subject matter. In one embodiment, the web browser 300 may include a plurality of tabs 310, each configured to display a web page or other document.

FIG. 3 also illustrates an embodiment of a web page of a content server or media provider. In various embodiments, this web page may be served directly from the content server. In another embodiment, this web page may be part of the presentation provided by the media player component of the media player apparatus. User interface (UI) elements 306 may be configured to display the contextual information related to the media file being played or selected. This contextual information may be included in the cached metadata file or downloaded from the content server, if operating in online mode.

The web browser may be configured to display a media player element 302 within which the media file and any advertisements may be displayed or played (e.g., an HTML Video tag, etc.). When in online mode, the content server may stream the media and associated file to the media player element 302. When in offline mode, the cached media and associated files may be displayed by the media player element 302.

In various embodiments, the advertisements may be displayed within the media player element 302. For example, the advertisements may be included within a commercial break of a television show. In some embodiments, advertisement 312 may be displayed in a separate UI element. In such an embodiment, the advertisements may be displayed substantially simultaneously with the media file, which may be displayed in the media player element 302. It is understood that the above are merely a few illustrative examples to which the disclosed subject matter is not limited.

In one embodiment, as described above, if an advertisement is selected within the media player element 302 when operating in offline mode, and the selection causes an action to be performed by the web browser 300, the web browser 300 may cache the action or enqueue it for later performance when the web browser 300 has returned to online mode. In various embodiments, this may include the creation of a new tab 310, in which the action is enqueued. Although, it is understood that the above is merely one illustrative example to which the disclosed subject matter is not limited.

The web page or media player presentation may include a number of buttons or UI elements 308 configured to allow a user to indicate what rights they would like to have regarding the media file. For example, three buttons may be provided that allow a user to play or stream the media file, cache the media file for offline playing, or purchase or license the media file. In an offline mode, some of the UI elements 308 may be disabled (e.g., the play or streaming button, etc.). Further, in one embodiment, one or more of the UI elements 308 may create a cacheable user interaction event similar to a cacheable user interaction event created when a user selects an advertisement in offline mode. For example, the “Purchase” button may create an interaction event that causes the web browser to initiate or completion the purchase of the media file when the web browser returns to an online mode.

In such an embodiment, the purchasing of a cached media file may include the removal of any association of advertisements from the media file, such that the media file may be played without the previously associated advertisements. In one embodiment, these advertisements may be disassociated form the media file, even if the web browser is operating in offline mode. In another embodiment, the disassociation may only occur after the web browser has returned to online mode and the content server or provider has received the payment for the purchase of the license to the media file. Similarly, other actions may be performed as a result of the purchase of a cached media file. For example, the media file may become unencrypted, moved to a user accessible portion of the local file system, etc., although it is understood that the above are merely a few illustrative examples to which the disclosed subject matter is not limited.

FIG. 4 is a diagram of an example embodiment of a metadata file 400 in accordance with the disclosed subject matter. In the illustrated embodiment, the metadata file 400 may include information organized into an Extensible Markup Language (XML) format. In a preferred embodiment, the metadata file 400 may be formatted in a JavaScript Object Notation (JSON) arrangement. It is understood that the above are merely a few illustrative examples to which the disclosed subject matter is not limited.

In one embodiment, the metadata file 400 may include a portion 402 that includes contextual information. This contextual information portion 402 may include information relating to the media contained in the media file (e.g., movie title, playtime, actors, genres, provider, studios, release date, etc.).

In various embodiments, the metadata file 400 may also include a portion 404 that includes DRM information. This DRM information portion 404 may include information relating to the access rights or restrictions associated with the media file. For example restrictions may include indications that the media file may only be cached for a certain period of time, be playable until a certain date, playable a certain number of times, within a geographic region, at a certain quality (e.g., number of pixels, number of audio tracks, bitrate, etc.), played via a certain port (e.g., the main display, an external video port, only via headphones, etc.), etc. In the illustrated embodiment, the DRM information portion 404 indicates that the media file will no longer be playable within 60 days of the date the media file was added or cached (May 18, 2010),It is understood that the above are merely a few illustrative examples to which the disclosed subject matter is not limited.

In some embodiments, the metadata file 400 may also include a portion 406 that includes advertisement information. This advertisement information portion 406 may include information relating to the association and playing of advertisements associated with the media file. In various embodiments, the advertisement information portion 406 may include a list of times, relative to the media file, that advertisements are to be played, which advertisements are to be played, where they are to be played (e.g., below where the media file is played, in place of the media file, etc.), etc., although it is understood that the above are merely a few illustrative examples to which the disclosed subject matter is not limited. For example, in the illustrated embodiment, a Flash Small Web Format (ad1.swf) file is to be played 20 minutes into the playing of the media file, and a web page (ad2.html) is to be displayed or “played” 40 minutes and 30 seconds into the playing of the media file. As can be seen by the inclusion of the web page ad2.html, a listed or explicitly referenced advertisement may include or reference other advertisement files (e.g., an image file, etc.).

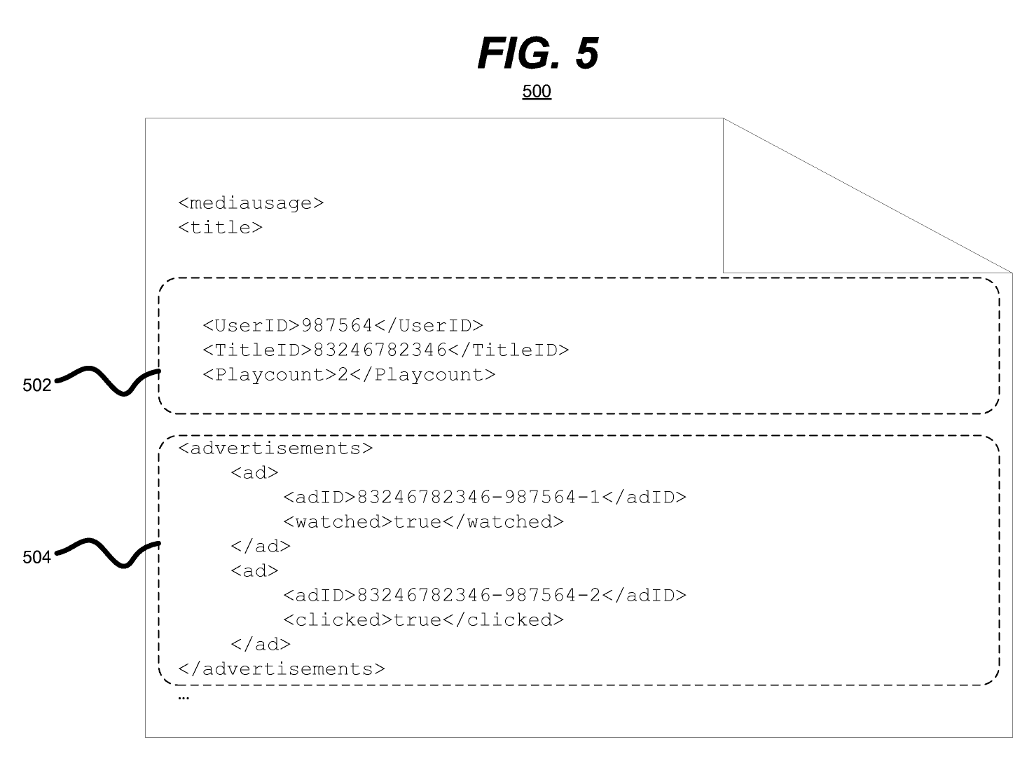

FIG. 5 is a diagram of an example embodiment of a usage data file 500 in accordance with the disclosed subject matter. As described above, in various embodiments, the web browser or media player apparatus may report usage data to a content provider or content server. In the illustrated embodiment, the usage data file 500 may include information organized into an Extensible Markup Language (XML) format. In a preferred embodiment, the usage data file 500 may be formatted in a JavaScript Object Notation (JSON) arrangement. However, each content provider may desire the usage data file 500 include a specific format. It is understood that the above are merely a few illustrative examples to which the disclosed subject matter is not limited.

In one embodiment, the usage data file 500 may include a media usage portion 502. The media usage portion 502 may include information regarding the user's usage of the media file (e.g., playcount, resume position, rating, bookmarks, annotations, notes, etc.), although it is understood that the above is merely one illustrative example to which the disclosed subject matter is not limited.

In one embodiment, the usage data file 500 may include an advertisement usage portion 504. The advertisement usage portion 504 may include information regarding the user's usage of the advertisements. For example, each advertisement may be identified (e.g., via a substantially unique identifier (UID), etc.) and usage information regarding that advertisement may be recorded. For example, it may be recorded whether or not the advertisement was watched or played, whether a user clicked or selected a portion of the advertisement, etc. In various embodiments, advertisement usage portion 504 may include cached actions related to the advertisements (e.g., purchasing requests, web page requests, etc.); although, as described above, some of the user actions may have been cached or enqueued via the web browser. It is understood that the above are merely a few illustrative examples to which the disclosed subject matter is not limited.

FIG. 6 is a diagram of an example embodiment of media and advertisement files in accordance with the disclosed subject matter. In one embodiment, the content server may provide the media player apparatus with a unified media file and advertisements 602. In such an embodiment, the content server may generate a unified file 602 such that the advertisements are “burned in” or “forced” onto the media file, and are seen by the media player apparatus as a single integrated file. In some embodiments, the various portions of the media file and the advertisements may be distinguishable (e.g., via chapter markings, etc.).

However, in a preferred embodiment, the media and advertisement files may be separate files 604. In such an embodiment, the media file 608 may be separate from the advertisements 610 (e.g., advertisements 601a, 610b, and 610c). This may be advantageous in that the content provider may only have to generate the media file once, and may dynamically determine which advertisement files 610 to associate with the media file 608 at the time of download. Further this may allow the content server to update or replace only the advertisement files 610 without updating to retransmitting the media file 608. Although, it is understood that the above are merely a few illustrative examples to which the disclosed subject matter is not limited.

In various embodiments, separate media and advertisement files 604 may be encapsulated or packaged as a single file for purposes of downloading. In such an embodiment, the media player apparatus may unpack or separate the individual media file 608 and advertisements 610 upon receipt of the encapsulated single file. Further, in various embodiments, the advertisement files 610 themselves (e.g., advertisement 610b) may include a plurality of files (e.g., web pages and images, etc.) in a container format (e.g., a multipart hypertext markup text language (multipart HTML or MHTML) file, etc.). These advertisement files 610 may be stored or cached in the container format or separated into individual files.

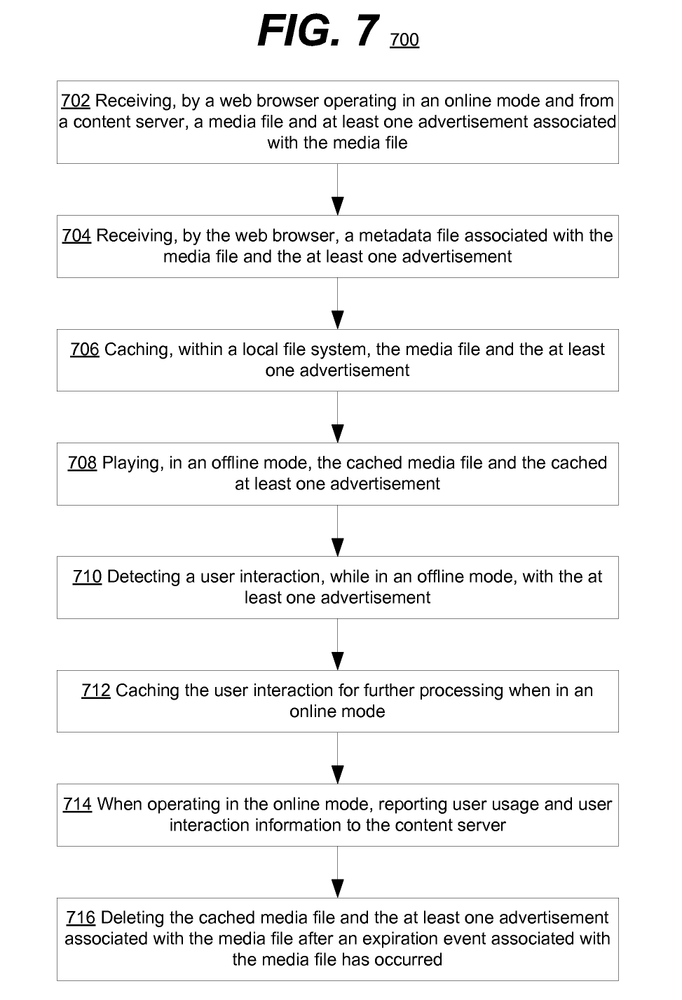

FIG. 7 is a flow chart of an example embodiment of a technique in accordance with the disclosed subject matter. In various embodiments, the technique 700 may be used or produced by the systems such as those of FIG. 2. Furthermore, portions of technique 700 may be used or produced by the elements or data files such as that of FIG. 3, 4, 5, or 6. Although, it is understood that the above are merely a few illustrative examples to which the disclosed subject matter is not limited. It is understood that the disclosed subject matter is not limited to the ordering of or number of actions illustrated by technique 700.

Block 702 illustrates that, in one embodiment, a media file and at least one advertisement associated with the media file may be received, as described above. In various embodiments, these files may be transmitted or sent from a content server, as described above. In some embodiments, receiving may include detecting a file type of the media file and determining, based upon the file type, if the media file is to be cached or instantly played, as described above. In various embodiments, one or more of the action(s) illustrated by this Block may be performed by the apparatuses or systems of FIG. 2, specifically the web browser or media player apparatus of FIG. 2, as described above.

Block 704 illustrates that, in one embodiment, a metadata file associated with the media file and the at least one advertisement may be received, as described above. In some embodiments, the metadata file may include timing information indicating when, in relation to the media file, the at least one advertisement should be played or how the advertisement should be played, etc., as described above. In various embodiments, one or more of the action(s) illustrated by this Block may be performed by the apparatuses or systems of FIG. 2, specifically the web browser or media player apparatus of FIG. 2, as described above.

Block 706 illustrates that, in one embodiment, the media file and the at least one advertisement may be cached, within a local file system for offline use, as described above. In various embodiments, caching the media file may include decrypting the media file and storing the media file within a secure portion of the local file system, as described above. In various embodiments, one or more of the action(s) illustrated by this Block may be performed by the apparatuses or systems of FIG. 2, specifically the DRM module or media player apparatus of FIG. 2, as described above.

Block 708 illustrates that, in one embodiment, the cached media file and the cached at least one advertisement may be played even though the web browser or media player apparatus is operating in an offline mode, as described above. In some embodiments, playing may include determining if the user has the access rights to play the media file, as described above.

In various embodiments, playing may include requesting an encryption key associated with the media file from a digital rights management module, as described above. Playing may also include decrypting the media file by employing the encryption key, as described above. In one embodiment, playing may further include providing advertisement timing instructions to a media player, wherein the advertisement timing instructions include a list of one or more times, relative to the media file, for the media player to suspend the playing of the media file and instead play at least one advertisement, as described above. Playing may also include playing, by the media player, the decrypted media file and at least one advertisement according to the advertisement timing instructions, as described above. In various embodiments, one or more of the action(s) illustrated by this Block may be performed by the apparatuses or systems of FIG. 2, specifically the DRM module or media player of FIG. 2, as described above.

Block 710 illustrates that, in one embodiment, a user interaction with the at least one advertisement may be detected while in an offline mode, as described above. In various embodiments, one or more of the action(s) illustrated by this Block may be performed by the apparatuses or systems of FIG. 2, specifically the web browser or media player of FIG. 2, as described above.

Block 712 illustrates that, in one embodiment, the user interaction may be cached for further processing when in an online mode, as described above. In various embodiments, caching the user interaction includes indicating to the web browser that, when the web browser returns to operating in an online mode, a web address associated with the user interaction should be accessed, as described above. In various embodiments, one or more of the action(s) illustrated by this Block may be performed by the apparatuses or systems of FIG. 2, specifically the web browser or media player of FIG. 2, as described above.

Block 714 illustrates that, in one embodiment, the user usage and user interaction information may be reported to the content server, when the apparatus or web browser is operating in an online mode, as described above. In various embodiments, one or more of the action(s) illustrated by this Block may be performed by the apparatuses or systems of FIG. 2, specifically the web browser or DRM module of FIG. 2, as described above.

Block 716 illustrates that, in one embodiment, the cached media file and the at least one advertisement associated with the media file may be deleted after an expiration event associated with the media file has occurred, as described above. In various embodiments, this may occur as a result of an instruction from the content server while the apparatus is in an online mode, as described above. In another embodiment, this may occur as an automated occurrence, while operating in an offline mode, due to information associated with the media file (e.g., in a metadata file, etc.), as described above. In various embodiments, one or more of the action(s) illustrated by this Block may be performed by the apparatuses or systems of FIG. 2, specifically the web browser or DRM module of FIG. 2, as described above.

Various implementations of the systems and techniques described herein can be realized in digital electronic circuitry, integrated circuitry, specially designed ASICs (application specific integrated circuits), computer hardware, firmware, software, and/or combinations thereof These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described herein can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described herein can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the disclosed subject matter.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A method comprising:
receiving, by a web browser operating in an online mode and from a content server, a media file and at least one advertisement associated with the media file;
caching, within a local file system, the media file and the at least one advertisement;
playing, in an offline mode, the cached media file and the cached at least one advertisement;
detecting a user interaction, while in an offline mode, with the at least one advertisement; and
caching the user interaction for further processing when in an online mode.

2. The method of claim 1, further comprising receiving, by the web browser, a metadata file associated with the media file and the at least one advertisement;
wherein the metadata file comprises timing information indicating when, in relation to the media file, the at least one advertisement should be played.

3. The method of claim 1, wherein caching the media file includes decrypting the media file and storing the media file within a secure portion of the local file system.

4. The method of claim 1, wherein caching the user interaction includes indicating to the web browser that, when the web browser returns to operating in an online mode, a web address associated with the user interaction should be accessed.

5. The method of claim 1, wherein playing the media file includes:
requesting an encryption key associated with the media file from a digital rights management module;
decrypting the media file by employing the encryption key;
providing advertisement timing instructions to a media player, wherein the advertisement timing instructions include a list of one or more times, relative to the media file, for the media player to suspend the playing of the media file and instead play at least one advertisement; and
playing, by the media player, the decrypted media file and at least one advertisement according to the advertisement timing instructions.

6. The method of claim 1, wherein the web browser is configured to act as an operating system.

7. The method of claim 1, further comprising deleting the cached media file and the at least one advertisement associated with the media file after an expiration event associated with the media file has occurred.

8. The method of claim 1, further comprising, when operating in the online mode, reporting user usage and user interaction information to the content server.

9. The method of claim 1, wherein receiving includes:
detecting a file type of the media file and determining, based upon the file type, if the media file is to be cached or instantly played; and
wherein playing includes determining if the user has the access rights to play the media file.

10. An apparatus configured to operate in an online mode and an offline mode, wherein when operating in the online mode the apparatus is communicatively coupled to a content server, and when operating in the offline the apparatus is not communicatively coupled to the content server, the apparatus comprising:
an operating system to:
receive, from the content server, a media file and at least one advertisement associated with the media file;
a non-volatile memory to cache, within a local file system, the media file and the at least one advertisement; and
a media player to:
play, while the apparatus is operating in the offline mode, the cached media file and the cached at least one advertisement,
detect a user interaction, while the apparatus is operating in the offline mode, with the at least one advertisement, and
cache the user interaction for further processing when the apparatus is operating in the online mode.

11. The apparatus of claim 10, wherein the operating system further:
receives, from the content server, a metadata file associated with the media file and the at least one advertisement,
wherein the metadata file comprises timing information indicating when, in relation to the media file, the at least one advertisement should be played.

12. The apparatus of claim 10, further comprising a Digital Rights Management (DRM) module to decrypt the media file and store the media file within a secure portion of the local file system.

13. The apparatus of claim 10, wherein the media player indicates to the operating system that, when the apparatus returns to operating in the online mode, a web address associated with the user interaction should be accessed.

14. The apparatus of claim 10, wherein the media player:
requests an encryption key associated with the media file;
decrypts the media file by employing the encryption key;
receives advertisement timing instructions, wherein the advertisement timing instructions include a list of one or more times, relative to the media file, for the media player to suspend the playing of the media file and instead play at least one advertisement; and
play the decrypted media file and at least one advertisement according to the advertisement timing instructions.

15. The apparatus of claim 10, wherein the operating system acts as a web browser.

16. The apparatus of claim 10, further including a Digital Rights Management (DRM) module to:
delete the cached media file and the at least one advertisement associated with the media file after an expiration event associated with the media file has occurred.

17. The apparatus of claim 10, wherein the operating system, when operating in the online mode, reports user usage and user interaction information to the content server.

18. The apparatus of claim 10, wherein the operating system detects a file type of the media file and determine, based upon the file type, if the media file is to be cached or instantly played.

19. A computer-readable medium including a computer program being tangibly embodied and including executable code that causes a media playing apparatus to:
receive, by the media playing apparatus operating in an online mode and from a content server, a media file and at least one advertisement associated with the media file;
cache, within a local file system, the media file and the at least one advertisement;
play, in an offline mode, the cached media file and the cached at least one advertisement;
detect a user interaction, while in an offline mode, with the at least one advertisement; and
cache the user interaction for further processing when in an online mode.

20. The computer-readable medium of claim 19, wherein the executable code causes a media playing apparatus to:
receive a metadata file associated with the media file and the at least one advertisement, wherein the metadata file comprises timing information indicating when, in relation to the media file, the at least one advertisement should be played; and
decrypt the media file and storing the media file within a secure portion of the local file system.
